(19) United States
(12) Patent Application Publication
(10) Pub. No.: US 2006/0026194 A1
(43) Pub. Date: Feb. 2, 2006

(54) System and method for enabling indexing of pages of dynamic page based systems

(75) Inventors: Bharat Bhushan, Bangalore (IN); Karlheinz Agsteiner, Sandhausen (DE); Deborah Corsi, Haverford, PA (US)

Correspondence Address: KENYON & KENYON, ONE BROADWAY, NEW YORK, NY, 10004, US

(73) Assignee: SAP AG

(21) Appl. No.: 11/176,141

(22) Filed: Jul. 6, 2005

Related U.S. Application Data
(60) Provisional application No. 60/586,275, filed on Jul. 9, 2004.
(60) Provisional application No. 60/586,730, filed on Jul. 12, 2004.

(51) Int. Cl. G06F 7/00

(52) U.S. Cl. 707/102

(57) ABSTRACT

In a system and method for interacting with dynamic data, a plurality of static pages associated with corresponding products of a database may be generated, operability of a plurality of dynamic pages that is each associated with a corresponding product of the database may be maintained subsequent to the generation of the static pages, an interactive session may be established in response to a request for a dynamic page but not in response to a request for a static page, and submission of a static page to a webcrawler may be omitted without a request from the webcrawler for the static page.

### CROSS-REFERENCE TO RELATED APPLICATIONS

This application claims the benefit of provisional application Ser. No. 60/586,275, filed Jul. 9, 2004 and of provisional application Ser. No. 60/586,730, filed Jul. 12, 2004.

### BACKGROUND

Search engines implement webcrawlers to fetch web pages for indexing by the search engines. The search engines index pages in order to determine which pages, if any, satisfy search criteria, such as search words. The webcrawlers can be directed to a particular web page in a number of ways. For example, a webcrawler can be directed to the particular web page automatically after starting at an origination page and traversing a set of web pages that are linked to each other and ultimately to the origination page. Alternatively, the webcrawler can receive a web page, e.g., that is sent by a user, for example an owner of the particular web page.

However, some web pages are dynamically generated, for example, in response to a user's request for the page. Such dynamic web pages are often used in systems that provide for interaction with data subject to frequent change. For example, a web shop for the sale of products provide for presentation of and interaction with catalog data, such as identity of products for sale, number of products for sale, price of the products, etc. Such data is subject to frequent change. The products that are available for purchase change. The price of the products frequently changes. Product features change. Therefore, sellers constantly update a file or database of such catalog data. A purchaser requests dynamic pages for interaction with the catalog data, for example to browse and purchase catalog products.

Many webcrawlers do not traverse or otherwise accept a dynamic page for indexing. For example, such webcrawlers identify a page as dynamic by special characters in the Uniform Resource Locator (URL), and do not fetch such identified pages for indexing.

In order to provide access to product catalog data via search engines, it is conventional to generate static pages that correspond to the catalog data. The static pages are not generated in response to a request for the page. They are generated prior to the page request and are retrieved from a memory location in response to the page request. The static pages, rather than dynamic pages, are indexed by search engines. However, the static pages are used instead of the dynamic pages, and legacy systems for which the static pages are generated are therefore significantly changed so that they refer to the static pages, rather than to the dynamic pages. For example, a legacy web shop which refers to dynamic pages for products that are on sale, is changed to refer to the static pages.

Furthermore, systems for the interaction with frequently changing data, e.g., web shops, often open interactive sessions, e.g., a shopping session. Such sessions are opened by generating a session object. The generation and maintenance of the session object uses processor time and uses memory space. For example, a basket is maintained in which the processor keeps track of the products a user selects for purchase. After indexing of the static pages, the search engines can return to a user a link to such a static page in response to a user search. Often, a user selects such a returned link because the link seems to be of interest. Once a page is returned in response to the selection, the user realizes that the page is in fact not of interest. However, as soon as the static page is returned in response to the selection of the link, processor time and memory is unnecessarily used to generate the session object.

Accordingly, there is a need in the art for a system and method for enabling the indexing of pages of dynamic-page based systems without requiring significant change to legacy systems, and for more efficiently using processor time and memory.

### BRIEF DESCRIPTION OF THE DRAWINGS

FIG. 1 is a block diagram that illustrates components of an example system, according to an example embodiment of the present invention.

FIG. 2 illustrates an example interaction between components of a system, according to an example embodiment of the present invention.

### DETAILED DESCRIPTION

Embodiments of the present invention relate to a computer system and method that may generate a corresponding static page, e.g., a Hyper Text Markup Language (HTML) page, for each group of data for which a dynamic page may be generated, e.g., for each product of a catalog database, without requiring significant change in legacy application environments in which the dynamic pages are generated, and that may conserve processor time.

After an update to such data, e.g., catalog data, a processor may generate a static web page associated with the updated catalog data. A dynamic page that corresponds to the generated static page may be generated and returned to a user in response to a page request even after generation of the static page. For example, a link may be provided to a dynamic page for selection by a user during an interactive session, e.g., a shopping session. Accordingly, references by a legacy application environment to dynamic pages, such as links to the dynamic pages, may be maintained.

The processor may maintain an index web page. The index page may include links to each generated static page, and may be submitted to a webcrawler. After generation of a static page, the processor may insert a link to the static page in the index page and may omit submitting the generated static page to the webcrawler. The webcrawler may traverse the generated static page since the static page is linked to the index page submitted to the webcrawler.

In one embodiment of the present invention, the processor may insert code into the static pages or a dynamic page ID into their URLs for redirection to a web shop for opening a web shop session and for generating and displaying a dynamic page instead of the static page.

In an alternative embodiment of the present invention, the processor may configure generated static pages so that an interactive session is not opened when a user accesses the static pages. On the other hand, the processor may configure dynamic pages so that the interactive session is opened when the user accesses the dynamic pages.

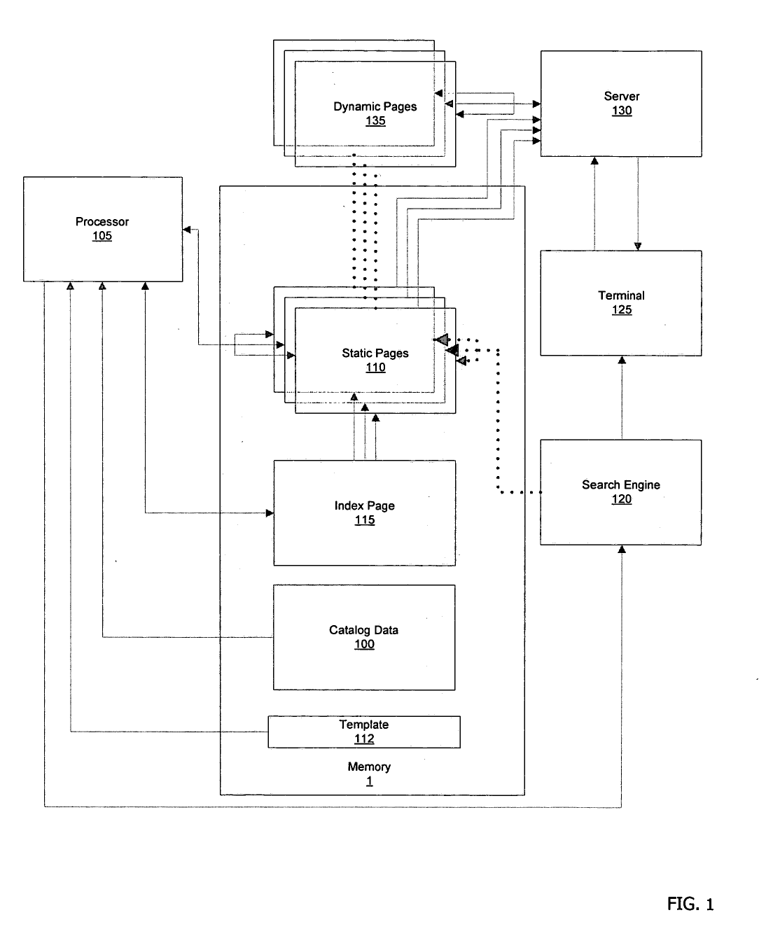

FIG. 1 is a block diagram that illustrates components of an example system according to an example embodiment of the present invention. Catalog data 100 may be stored in a memory 1. The catalog data 100 may include, for example, product information, such as price, number in stock, and shipping information, for each of a number of products. After entry of catalog data 100, a processor 105 may generate a static page 110 based on the entered catalog data 100. For example, the processor 105 may retrieve a page generation template 112, copy the template 112 as a new page, and insert data elements of the catalog data 100 into the template copy at insertion points. For example, the template 112 may include indicators that identify the type of data to be inserted at various points within the template copy. The processor 105 may then store the generated static page 110 in the memory 1. In one example embodiment, a number of different templates 112 may provided. For example, different templates 112 may be used for different categories of products.

In an embodiment of the present invention, the processor 105 may generate an index page 115 that includes for each generated static page 110 a corresponding entry. For example, the processor 105 may generate the index page 115 immediately following generation of the first static page 110, and may insert an index entry immediately following each static page generation. Alternatively, the processor 115 may generate all of the static pages 110, and may subsequently generate the index page 115 and insert entries for all of the generated static pages 110. Each index page entry may include a page address link, e.g., a URL, for its corresponding static page 110. In one embodiment, to keep the size of the index page 115 from becoming very large, a number of index pages 115 may be generated. Each of the index pages 115 may include links to different static pages 110. For example, different index pages 115 may be generated for different categories of products.

After the processor 105 inserts into the index page 115 an entry for each of the generated static pages 110, the processor 105 may transmit the index page 115 towards a webcrawler of a search engine 120. Once the webcrawler receives the index page 115, the webcrawler may traverse the links in the index page 115 that point to the generated static pages 110. The webcrawler may therefore enable the search engine 120 to index each of the static pages 110, even without the transmission by the processor 105 of the static pages 110 to the webcrawler when the static pages 110 are generated. The catalog data for which dynamic pages may be generated may therefore be indexed by the search engine 120.

In an embodiment of the present invention, when a change is made to the catalog data 100, the processor 105 may accordingly update the static pages 110 and the entries of the index page 115. Particularly with respect to a web shop, an update to the catalog data 100 may include, e.g., a change to a status of a product that was previously for sale but is no longer for sale, an addition of a new product put up for sale, or a change to information related to a product that is for sale, such as price or quantity. When a product is added, the processor 105 may generate a new static page 110 and insert a corresponding new entry into the index page 115. When the status of a product is changed so that it is no longer for sale, the processor 105 may remove from the index page 115 the product's corresponding entry. When information related to a product is changed, the processor 105 may remove from the index page 115 the entry corresponding to the previously generated static page 110, may generate a new static page 110, and may insert into the index page 115 a new entry corresponding to the new static page 110.

In one embodiment of the present invention, the processor 105 may periodically check the catalog data 100 for changes. Alternatively, when a change is made to the catalog data 100, the processor 105 may be automatically alerted of the change. In response to the alert, the processor 105 may update the static pages 110 and the index page 115. Alternatively, a user may instruct the processor 105 to update the static pages 110 and the index page 115. In response, the processor 105 may check the catalog data 100 to determine which changes, if any, have been made. If any changes have been made, the processor 105 may accordingly update the static pages 110 and the index page 115.

In one embodiment of the present invention, after the processor 105 makes all of the changes corresponding to the changes to the catalog data 100, the processor 105 may resubmit the index page 115 to the webcrawler so that the webcrawler may re-traverse the links of the index page 115, note which pages have been removed, and provide the new pages to the search engine 120 for indexing.

In an alternative embodiment, the processor 105 may omit resubmitting the index page 115 to the webcrawler since conventional webcrawlers periodically re-traverse already indexed pages to ensure that the index of the search engine 120 is up-to-date. Therefore, even if the processor 105 does not resubmit the index page 115 to the webcrawler after updating the index page 115 and the static pages 110, the webcrawler would eventually obtain the index page 115. The index of the search engine 120 would accordingly be updated.

In an embodiment of the present invention, a user at a terminal 125 may transmit towards the search engine 120 a request to conduct a search for web pages according to input search criteria, e.g., search words. In response, the search engine 120 may access its index of pages to determine which, if any, of the indexed pages satisfy the search criteria. If any of the static pages 110 satisfies the search criteria, e.g., pertains to the search words, the search engine 120 may return to the terminal 125 a link to the “matching” static page 110. If the user selects the link to the static page 110, a server 130 may retrieve the static page 110 from the memory 1, and may transmit the static page 110 to the terminal 125. It will be appreciated that the processor 105 may be located at the server 130 and perform processes of the server 130. Alternatively, the server 130 may include its own processor to perform processes of the server 130.

The search engine 130 may return to the terminal 125 a link to the index page 115. The user at the terminal 125 may accordingly select directly in the index page 115 a link to a static page 110. Accordingly, the processor 105 may insert into the index page 115 data other than links to static pages 110. For example, the index page 115 may include a description of the content of the index page 115, so that the user at the terminal 125 may informatively select links in the index page 115 to static pages 110.

In an embodiment of the present invention, the user at the terminal 125 may directly enter a URL of a static page 110 in order to request the static page 110. In response, the server 130 may retrieve the requested static page 110 from the memory 1, and may transmit the static page 110 towards the terminal 125. The user may also directly enter a URL in order to request a dynamic page 135. Although dynamic pages do not exist until they are requested, the dotted lines in FIG. 1 between the static pages 110 and the non-existent dynamic pages 135 that may be generated in response to requests, illustrate that each static page 110 may correspond to a particular dynamic page 135 that may be generated. More particularly, for each static page 110 that a user may request, the user may instead request a corresponding dynamic page 135. In response to the request for the dynamic page 135, the server 130 may generate the requested dynamic page 135 and transmit it towards the terminal 125.

In one embodiment of the present invention, the user at the terminal 125 may also request a dynamic page 135 by selecting in a returned static page 110, a link to other pages. Since the dynamic pages 135 that are available for retrieval may change over time, the static pages 110, including links to dynamic pages 135 may become outdated. Accordingly, in one embodiment of the present invention, the static pages 110 may be regenerated, e.g., periodically.

Alternatively, the processor 105 may insert into each static page 110 it generates, a link to a master dynamic page 135, which may be constantly maintained. After the user obtains the static page 110 at the terminal 125, the user may select the link to the master dynamic page 135. In response, the server 130 may dynamically generate and transmit the master dynamic page 135, which may include links to other dynamic pages 135 that correspond to the generated static pages 110. Since the master dynamic page 135 is dynamically generated, it may reflect changes in the availability of individual dynamic pages 135.

Alternatively, instead of links to particular dynamic pages 135, the processor 105 may insert into the static pages 110 a link to the server 130. In response to the selection of the link to the server 130, the server 130 may generate a dynamic page 135 that includes links to other dynamic pages 135 that correspond to the static pages 110.

In an alternative embodiment, the processor 105 may generate the static pages 110 without links to other dynamic pages 135. Instead, in response to a request for a static page 110, the server 130 may retrieve the requested static page 110 from the memory 1, and may update the static page 110 with links to dynamic pages 135 before transmitting the static page 110 towards the terminal 125.

In an alternative embodiment, when the server 130 receives a request for a static page 110, the server 130 may transmit towards the terminal 125 a dynamic page 135 that corresponds to the requested static page 110, instead of the requested static page 110. The dynamic page 135 transmitted towards the terminal 125 may include links to other dynamic pages 135.

In response to a search request by a user, the search engine 120 may return links to web pages, including static pages 110, that satisfy the search criteria entered by the user, but that are not ultimately of interest to the user. The user may select one of the returned links to a static page 110. After the user views contents of the static page 110, the user may determine that the static page 110 is not of interest and may refrain from interacting with the page, e.g., by selecting any links in the static page 110. In an embodiment of the present invention, the server 130 may selectively open an interactive session, e.g., a shopping session, only in response to a request for a dynamic page 135, and not in response to a request for a static page 110. Accordingly, when the user selects a link to a static page 110 returned by the search engine 120, the server would not open the interactive session. However, if the user interacts with the returned static page 110, e.g., selects a link in the static page 110 or indicates a desire to order a product, the server 130 may then open an interactive session, e.g., a session in which the user may enter the order. To open the interactive session, the server 130 may create a new session object that may be maintained until the session is terminated.

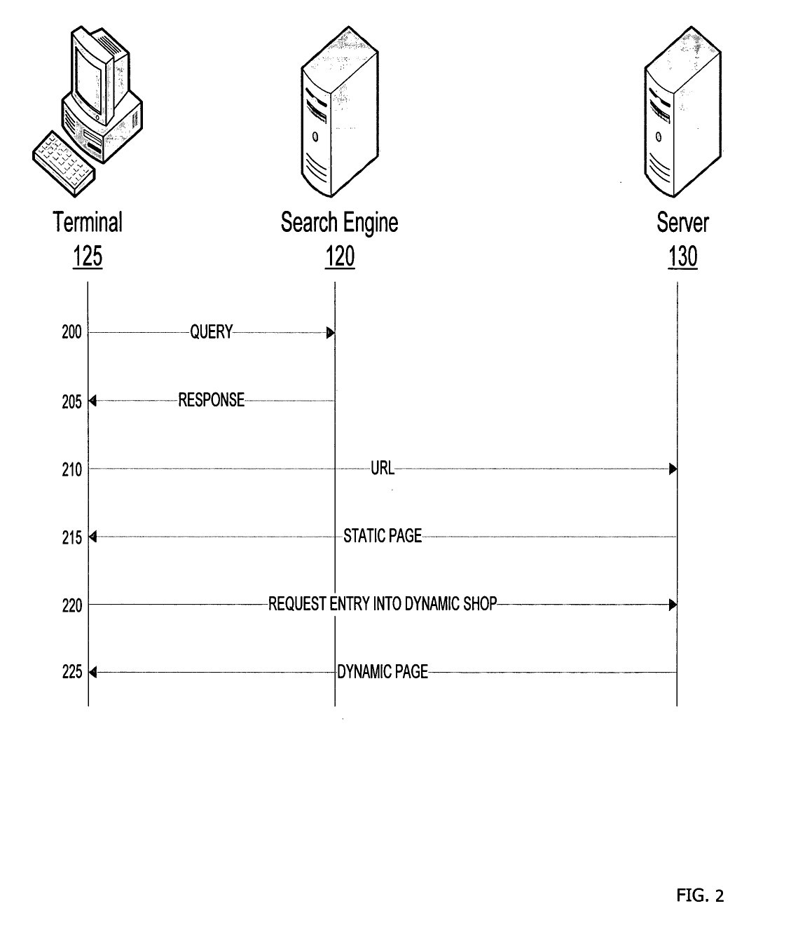

FIG. 2 is a diagram that illustrates a sequence of a procedure according to an example embodiment of the present invention during which an interactive communications session is ultimately opened following a web page search conducted at the terminal 125. At 200, a user at the terminal 125 may query the search engine 120 for pages that satisfy search criteria. In 200, the search engine 120 may transmit a response to the terminal 125. The response may include links to the pages that satisfy the search criteria. If the search engine 120 determines that a static page 110 satisfies the search criteria, then the search engine 120 may transmit towards the terminal 125 a link to the static page 110.

In 210, the user at terminal 125 may select the link to the static page 110. Based on the URL of the selected link, a request for the static page 110 may be transmitted by the terminal 125 towards the server 130. In one example embodiment of the present invention, in 215, the server 130 may transmit the static page 110 towards the terminal 125 in response to the page request. However, at this time, the server 130 may refrain from opening an interactive session, e.g., web shop interactive session.

In 220, the user may enter the dynamic shop by selecting a link in the returned static page 110, or by interacting with the static page 110 in some other way. For example, in response to an interaction with the static page 110, such as a selection of a link, the terminal 125 may transmit towards the server 130 a request for generation and transmission of a dynamic page 135 for a particular product or a general request to open an interactive session. In response, the server 130 may open an interactive session for the terminal 125. After 220, the server 130 may, in 225, transmit dynamic pages 135 in response to all page requests made by the terminal 125, e.g., as long as the interactive session is maintained.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method for interfacing a product database with a webcrawler, comprising:
for each of a plurality of products, generating a static web page populated with data from the database representing the product, for indexing by the webcrawler; and
for each of the plurality of products, in response to a request for a page populated with data from the database representing the product:
generating a dynamic web page; and
transmitting the dynamic page.

2. The method of claim 1, wherein, in response to a static page request, a static page is returned, and in response to a dynamic page request, a dynamic page is returned.

3. The method of claim 1, further comprising:
storing a template; and
for each of the plurality of products:
retrieving the template; and
retrieving the data representing the product,
wherein the generation of a static page includes:
copying the template; and
inserting the retrieved data into insertion points of the template.

4. The method of claim 1, further comprising:
generating an index of the generated static pages; and
submitting the index to the webcrawler.

5. The method of claim 4, further comprising:
subsequent to an update to the database after the generation of the index, updating the plurality of static pages according to the update to the database; and
updating the index according to the update to the plurality of static pages.

6. The method of claim 5, further comprising:
determining whether an update to the plurality of static pages is required at least one of periodically, in response to an update instruction, and in response to the update to the stored dynamic data.

7. The method of claim 5, wherein:
the update to the database includes at least one of an entry of a new product data and a removal of an old entry;
the update to the plurality of static pages includes at least one of a generation of a new static page and a removal of an old static page;
the index includes for each of the plurality of static pages a corresponding index line; and
the update to the index includes at least one of a generation of a new index line and a removal of an old index line.

8. The method of claim 7, further comprising:
resubmitting the index to the webcrawler in response to the update to the index.

9. The method of claim 7, wherein the plurality of static pages is not submitted to the webcrawler.

10. The method of claim 1, wherein, in response to a web page search, a link to a particular one of the plurality of static pages is returned, and wherein the particular static page includes links for establishing an interactive session, the method further comprising:
in response to a selection of the returned link to the particular static page, displaying the static page without establishing the interactive session; and
establishing the interactive session in response to a selection in the particular static page of any of the links for establishing the interactive session.

11. The method of claim 10, wherein the links for establishing the interactive session include a link to a particular one of the plurality of dynamic pages.

12. The method of claim 1, wherein the generation of the static web page includes embedding in the static web page a redirection link that, when interpreted by a browser, instructs the browser to request a dynamic page populated with data corresponding to the data of the static page.

13. A method for enabling indexing of a products database, comprising:
generating a plurality of static pages, each associated with a corresponding product of the database;
storing the static pages at a location accessible by a webcrawler;
generating an index page containing links to the static pages;
transmitting the index page to the webcrawler;
wherein, for each of the plurality of static pages, if a request for the static page is not received from the webcrawler, the static page is not transmitted to the webcrawler.

14. The method of claim 13, further comprising:
updating the database;
based on the update to the database, updating the plurality of static pages to include a new static page; and
based on the update to the plurality of static pages, updating the index,
wherein, the new static page is not transmitted to the webcrawler if a request for the static page is not received from the webcrawler.

15. The method of claim 14, further comprising:
re-transmitting the index to the webcrawler in response to the update to the index.

16. A method for interacting with pages that include a plurality of static pages and a plurality of dynamic pages, each of the plurality static pages and each of the plurality of dynamic pages corresponding to a corresponding one of the plurality of products of a products database, comprising:
establishing an interactive session in response to a page request upon a condition that the requested page is one of the plurality of dynamic pages.

17. A method for providing web pages, comprising:
in response to a selection of a link to a static web page, retrieving the static page;
in accordance with a redirect command embedded in the static web page, retrieving a dynamic web page that is associated with a product with which the static page is associated; and
displaying the dynamic web page.

18. The method of claim 17, wherein, in response to a query, a search engine returns the link.

19. A method for interfacing a product database with a web crawler, comprising:
for each of a plurality of products, generating a static web page populated with data from the database representing the product,
generating an index page having links to each of the static web pages,
storing the index page and each of the static web pages at a location accessible by one or more web crawlers;
submitting the index page to one or more web crawlers,
wherein the generation of the static page includes embedding in the static page a redirection link that, when interpreted by a browser, instructs the browser to request a dynamic page populated with the data from the database representing the product.

20. An article of manufacture comprising a computer-readable medium having stored thereon instructions adapted to be executed by a processor, the instructions which, when executed, define a method for interfacing a product database with a webcrawler, the method comprising:
for each of a plurality of products, generating a static web page populated with data from the database representing the product, for indexing by the webcrawler; and
for each of the plurality of products, in response to a request for a page populated with data from the database representing the product:
generating a dynamic web page; and
transmitting the dynamic page.
